(19) United States
(12) Patent Application Publication
(10) Pub. No.: US 2010/0300857 A1
(43) Pub. Date: Dec. 2, 2010

(54) Key switch

(76) Inventors: Chia-Fa Cheng, Tu-Cheng City (TW); Yu-Hsiang Ting, Tu-Cheng City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/453,894

(22) Filed: May 27, 2009

(51) Int. Cl. H01H 13/70

(52) U.S. Cl. 200/344

(57) ABSTRACT

A key switch includes a fixing base having a fixing board. The fixing board has an installing trough and a plurality of positioning rods extending upwards therefrom and arranged around the installing trough. A resilient assembly has a first connecting portion and a second connecting portion engaged in the installing trough. A key cap includes a rectangular top plate and lateral plates extending downwards from edges of the top plate and connecting with one another. The top plate has a substantial middle portion connected with the first connecting portion of the resilient assembly, with the positioning rods substantially disposed at inner corners of the key cap to lean against of the corresponding lateral plates. The lateral plates are suspended above the fixing board for leaving a vertical displacement so that the key cap can be urged to move upwards and downwards along the positioning rods.

### BACKGROUND OF THE INVENTION

1. Field of the Invention

The present invention relates to a key switch, and more particularly to a key switch which is flexible for use in a computer keyboard.

2. The Related Art

The most common way of inputting information into a computer is through a keyboard including a number of key switches to be pressed. Each key switch is required to be vertically pressed downwards to trigger a circuit for generating a signal, without stuck key. U.S. Pat. No. 7,498,536 describes a key structure of a computer keyboard which comprises a key cap, a linkage mechanism, a fixed base, a resilient assembly, a membrane circuit board and a supporting -board under the membrane circuit board. The linkage mechanism is disposed between the key cap and the fixing base, and includes a first supporting frame and a second supporting frame, which pivot together to form a scissors-shaped structure. The resilient assembly is placed on the membrane circuit board and passes through the fixing base to elastically support the key cap, and functioned as a switch. When the key cap is pressed, the resilient assembly is driven downwards and then becomes the switch that can trigger the corresponding circuit on the membrane circuit board to generate the electronic signal. However, the engagement between the first supporting frame and the second supporting frame and the means for the linkage mechanism connecting with the key cap and the fixed base are complicated and not flexible enough, which are possible to result in the failure for inputting information because of the key stuck or biased. In addition, such key structure may increase the difficulties of manufacturing and take more assembling time. So it is desirable to design a key switch which overcomes the disadvantages mentioned above.

### SUMMARY OF THE INVENTION

Accordingly, an object of the present invention is to provide a key switch which is flexible for use in a computer keyboard. The key switch includes a fixing base having a fixing board. The fixing board has an installing trough at a top thereof and a plurality of positioning rods extending upwards therefrom and arranged around the installing trough. A resilient assembly adhered onto the fixing board has a first connecting portion and a second connecting portion engaged in the installing trough. A key cap includes a rectangular top plate and lateral plates extending downwards from edges of the top plate and connecting with one another. The top plate has a substantial middle portion connected with the first connecting portion of the resilient assembly, with the positioning rods substantially disposed at inner corners of the key cap to lean against the corresponding lateral plates. The lateral plates are suspended above the fixing board for leaving a vertical displacement so that the key cap can be urged to move upwards and downwards along the positioning rods.

As described above, the positioning rods are substantially disposed at the inner corners of the key cap and rely on the corresponding lateral plates, which makes the key cap move upwards and downwards smoothly along the positioning rods, preventing the stuck key condition. Meanwhile, such structure of the key switch is simple and easier to manufacture and assembly.

### BRIEF DESCRIPTION OF THE DRAWINGS

The present invention will be apparent to those skilled in the art by reading the following description, with reference to the attached drawings, in which:

FIG. 1 is an assembled, perspective view of a key switch of an embodiment according to the present invention;

FIG. 2 is an exploded, perspective view of the key switch shown in FIG. 1;

FIG. 3 is a perspective view of a key cap of the key switch shown in FIG. 2 viewed from a bottom angle;

FIG. 4 is a perspective view of a resilient assembly of the key switch shown in FIG. 2 viewed from a bottom angle;

FIG. 5 is a cross-sectional perspective view of the key switch shown in FIG. 1; and

FIG. 6 is a cross-sectional perspective view of the key switch shown in FIG. 1, wherein the key cap is pressed downwards.

### DETAILED DESCRIPTION OF THE EMBODIMENT

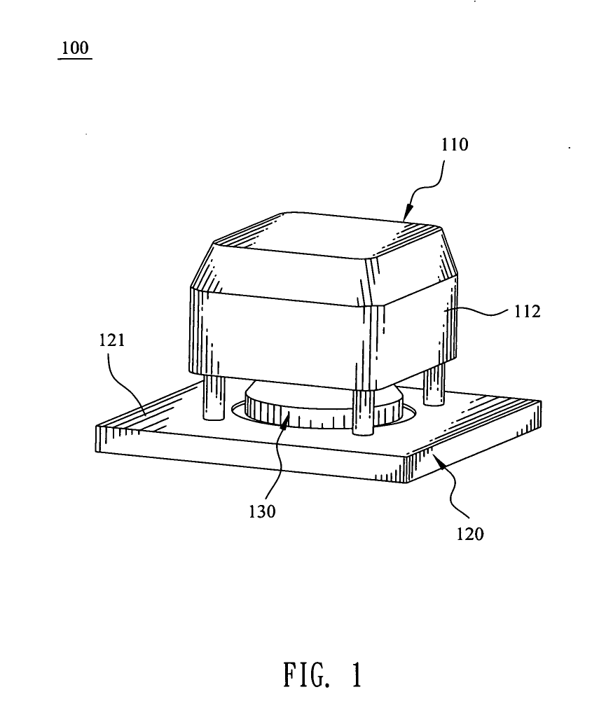

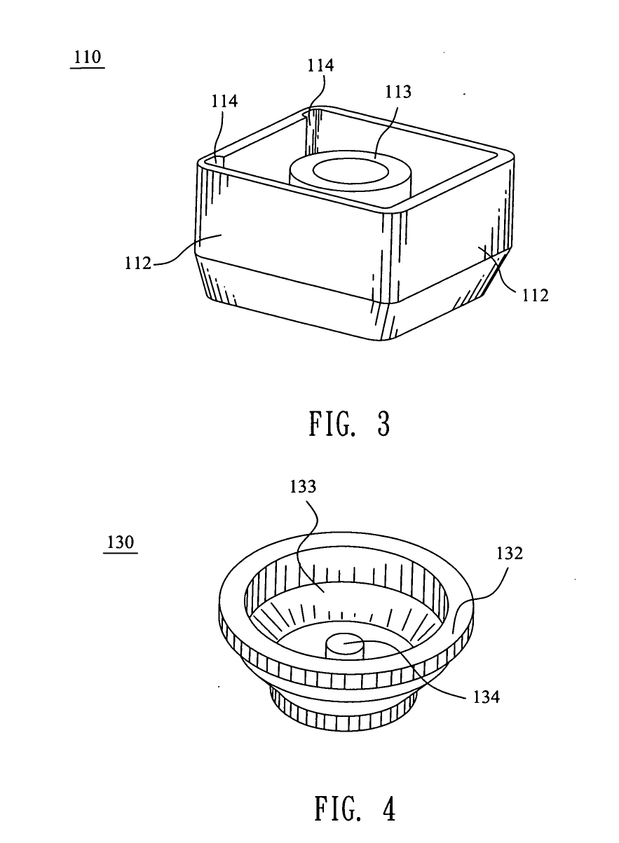

With reference to FIGS. 1-3, a key switch 100 in accordance with the present invention generally comprises a key cap 110, a fixing base 120 disposed under and spaced away from the key cap 110, and a resilient assembly 130 placed between the key cap 110 and the fixing base 120. The key cap 110 is substantially shaped like a square cap, and has a top plate 111 for receiving an external pressing force and four lateral plates 112 extending downwardly from edges of the top plate 111, connecting with each other. The top plate 111 is extended downwards from a middle portion of an inner surface thereof to form a barrel 113. In this embodiment, one of the lateral plates 112 is formed with two guiding grooves 114 at two opposite ends of an inner surface thereof, extending upwards and downwards.

The fixing base 120, which may be made of plastic material, has a rectangular fixing board 121. The fixing board 121 has a circular installing trough 122 at a middle portion of a top thereof for fixing the resilient assembly 130, and a plurality of positioning rods 123 extending upwards from the top thereof and around the installing trough 122. In this embodiment, there are four the positioning rods 123 arranged in two rows, designated 124 and 125. The positioning rods 124 are movably received in the guiding grooves 114, and the positioning rods 125 are respectively located at two contiguous corners of the key cap 110, each leaning against inner surfaces of the two intersecting lateral plates 112, for guiding the key cap 110 to move upwards and downwards.

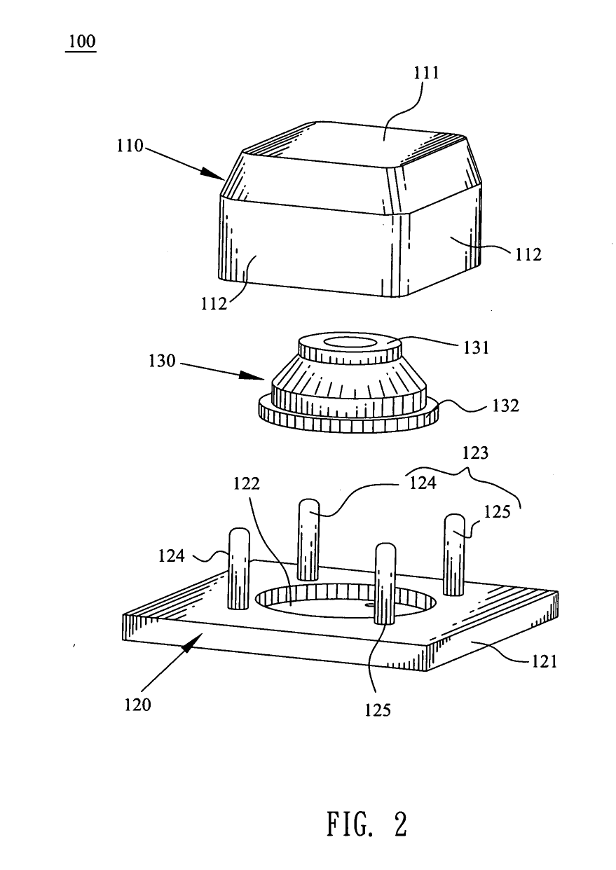

Please refer to FIG. 2 and FIGS. 4-5, the resilient assembly 130, made of an elastomer such as rubber, is substantially an inverted-bowl shape and defines a first connecting portion 131 at an upper end thereof and connecting with the key cap 110, a second connecting portion 132 at a lower end thereof, and a chamber 133. The first connecting portion 131 has an outer diameter substantially the same as that of the barrel 113. Herein, the first connecting portion 131 faces and is stuck to the bottom of the barrel 113 by adhesive. The second connecting portion 132 is a ring shape and has an outer diameter larger than that of the first connecting portion 131 and substantially the same as a diameter of the installing trough 122 for being engaged with each other. The chamber 133 has a contact pin 134 extending downwards from a top thereof. The contact pin 134 is within the chamber 133 and has a distal end spaced away from a plane of a bottom of the installing trough 122 with a predetermined distance when the resilient assembly 130 is assembled to the fixing base 130.

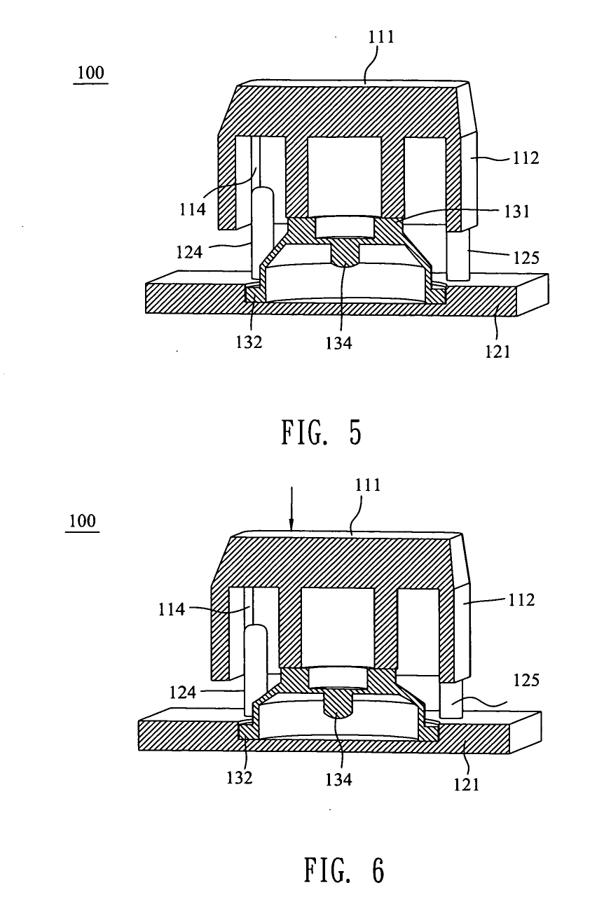

Referring to FIGS. 5-6, the resilient assembly 130 is placed on the fixing base 120, with the second connecting portion 132 received in the installing trough 122. A circuit board (not shown) is located on the bottom of the installing trough 122 and within the second connecting portion 132, spaced away from the contact pin 134. The key cap 110 is supported by the resilient portion 132 to suspend above the fixing board 121, with bottom edges of the lateral plates 112 spaced away from the fixing board 121 with a predetermined distance to leave a sufficient vertical displacement for activating the circuit board. The positioning rods 124 and 125 are slidably and respectively received in the corresponding guiding grooves 114 and the corresponding corners between the lateral plates 112, for guiding the key cap 110 to move upwards and downwards with respect to the fixing base 120. When the key cap 110 is pressed downwards along the positioning rods 123, the resilient assembly 130 is compressed to make the contact pin 134 move downwards to trigger the circuit board for generating an electronic signal.

As described above, the positioning rods 123 are substantially disposed at four corners of the key cap 110 and rely on the corresponding lateral plates 112, which makes the key cap 110 move upwards and downwards smoothly along the positioning rods 123, preventing the stuck key condition. Meanwhile, such structure of the key switch 100 is simple and easier to manufacture and assembly.

The foregoing description of the present invention has been presented for purposes of illustration and description. It is not intended to be exhaustive or to limit the invention to the precise form disclosed, and obviously many modifications and variations are possible in light of the above teaching. Such modifications and variations that may be apparent to those skilled in the art are intended to be included within the scope of this invention as defined by the accompanying claims.

What is claimed is:

1. A key switch, comprising:
a fixing base having a fixing board, the fixing board having an installing trough at a top thereof and a plurality of positioning rods extending upwards therefrom and arranged around the installing trough;
a resilient assembly adhered onto the fixing board having a first connecting portion and a second connecting portion engaged in the installing trough; and
a key cap having a rectangular top plate and lateral plates extending downwards from edges of the top plate and connecting with one another, the top plate having a substantial middle portion connected with the first connecting portion of the resilient assembly, with the positioning rods substantially disposed at inner corners of the key cap to lean against the corresponding lateral plates, the lateral plates suspended above the fixing board for leaving a vertical displacement so that the key cap can be urged to move upwards and downwards along the positioning rods.

2. The key switch as claimed in claim 1, wherein one of the lateral plates is formed with two guiding grooves at two opposite ends of an inner surface thereof, extending upwards and downwards for guiding the positioning rods.

3. The key switch as claimed in claim 1, wherein the resilient assembly is an inverted-bowl shape, and defines the first connecting portion at an upper end thereof and the second connecting portion at a lower end thereof to show a ring shape, an outer diameter of the first connecting portion is less than that of the second connecting portion.

4. The key switch as claimed in claim 3, wherein the top plate of the key cap is extended downwards to form a barrel, the barrel has an outer diameter substantially the same as that of the first connecting portion, and is stuck with the first connecting portion by the use of adhesive.

5. The key switch as claimed in claim 3, wherein the resilient assembly has a chamber, a top of the chamber is extended downwards to form a contact pin, spaced away from a bottom of the installing trough with a predetermined distance when the resilient assembly is assembled to the fixing base.
